(19) United States
(12) Patent Application Publication
(10) Pub. No.: US 2025/0058764 A1
(43) Pub. Date: Feb. 20, 2025

(54) DRIVER TORQUE DEMAND TO ENABLE COORDINATION BETWEEN VEHICLE TORQUE SOURCES

(71) Applicant: GM Global Technology Operations LLC, Detroit, MI (US)

(72) Inventors: Kuldip Dhananjay Kalushe, Canton, MI (US); Alexander Kellum Cox, Waterford, MI (US)

(73) Assignee: GM Global Technology Operations LLC, Detroit, MI (US)

(21) Appl. No.: 18/449,686

(22) Filed: Aug. 14, 2023

(51) Int. Cl. B60W 20/15; B60W 10/06; B60W 10/08

(52) U.S. Cl. CPC B60W 20/15; B60W 10/06; B60W 10/08; B60W 2510/0657; B60W 2510/083; B60W 2520/10; B60W 2710/0666; B60W 2710/083; B60W 2720/106

(57) ABSTRACT

A control system for a vehicle having a vehicle drive system and a plurality of torque sources connected to the vehicle drive system instructs a first torque source of the plurality of torque sources to provide an instantaneous torque to the vehicle drive system. The data processing hardware further receives a vehicle drive requested torque output and obtains a first available torque source output of the first torque source. The data processing hardware calculates a first torque error based on the requested torque output and the first available torque source output for the first torque source. The data processing hardware determines whether the first torque error exceeds a torque error threshold, and, when the first torque error exceeds the torque error threshold, activates a first supplemental torque source of the plurality of the torque sources to provide a first supplemental torque output to the vehicle drive system.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to systems and methods for detecting torque enabling coordination between vehicle torque sources.

Passenger comfort and fuel efficiency have set forth increasing demands on automotive vehicle designs. It is a primary goal of most vehicle designs to provide a more efficient vehicle without having to sacrifice vehicle performance. Moreover, and as alternative vehicle propulsion systems are implemented, vehicle performance and fuel efficiency are sometimes in opposition to each other.

A hybrid vehicle is a vehicle that has two sources of propulsion. A hybrid electric vehicle (HEV) is a vehicle wherein one of the sources of propulsion is electric and the other source of propulsion may be derived from fuel cells or an internal combustion engine (ICE) that burns diesel, gasoline, or any other source of fuel. Generally, a hybrid vehicle utilizes either one or two drivetrains wherein the internal combustion engine (ICE) provides torque to one of the drivetrains and an electrical driving force is applied to either of both of the drivetrains.

In order to operate the internal combustion engine (ICE) of a hybrid vehicle, a fuel source must be consumed. This causes the engine to generate emissions and the reduction of such emissions is a primary goal of any hybrid vehicle design. On the other hand, an electric drive system produces little or no emissions. However the operation of such a system draws energy from a battery or a plurality of batteries, which ultimately must be recharged.

Accordingly, and in order to operate in a most efficient manner, either one or both of the energy sources of a hybrid vehicle should be operated in accordance with the most efficient usage of energy.

### SUMMARY

In one configuration, a computer-implemented method that, when executed by data processing hardware of a vehicle having a vehicle drive system and plurality of torque sources connected to the vehicle drive system, causes the data processing hardware to perform operations. One operation includes instructing a first torque source of the plurality of torque sources to provide an instantaneous torque to the vehicle drive system. Another operation of the method includes receiving a requested torque output of the vehicle drive system. Another operation of the method includes obtaining a first available torque source output of the first torque source. Yet another operation includes calculating a first torque error based on the requested torque output and the first available torque source output for the first torque source. Another operation includes determining whether the first torque error exceeds a torque error threshold. When the first torque error exceeds the torque error threshold, the method includes activating a first supplemental torque source of the plurality of the torque sources to provide a first supplemental torque output to the vehicle drive system.

The method may include one or more of the following optional features. In some examples, the operations further include obtaining a supplemental available torque source output of the first supplemental torque source, calculating an aggregate torque error based on the requested torque output and the supplemental available torque source output, determining whether the aggregate torque error exceeds the torque error threshold, and when the aggregate torque error exceeds the torque error threshold, instructing a second supplemental torque sources of the plurality of the torque sources to provide a second supplemental additional torque output to the vehicle drive system.

In some examples, the operations further include determining the requested torque output based on a measured vehicle speed and a requested vehicle speed. In some configurations, the first available torque source output includes at least one of an instantaneous current torque source output component and a maximum current torque source output component. In some implementations, activating the first supplement torque source from the plurality of torque sources includes activating an available one of the torque sources having a highest efficiency score. In some examples, the plurality of torque sources includes one or more electric motors. In these examples, the plurality of torque sources may include an internal combustion engine.

In some configurations, the operations further include instructing the first supplemental torque source to execute a ramp-up period prior to providing the first supplemental torque output. In these configurations, the ramp-up period may include operating the first supplemental torque source in an unloaded state prior to providing the first supplemental torque output.

In another aspect of the disclosure, a control system for a vehicle having a vehicle drive system and plurality of torque sources connected to the vehicle drive system is provided. The control system includes data processing hardware and memory hardware in communication with the data processing hardware, the memory hardware storing instructions that when executed on the data processing hardware cause the data processing hardware to perform operations. One operation includes instructing a first torque source of the plurality of torque sources to provide an instantaneous torque to the vehicle drive system. Another operation includes receiving a requested torque output for the vehicle drive system. Yet another operation includes obtaining a first available torque source output of the first torque source. A further operation includes calculating a first torque error based on the requested torque output and the first available torque source output for the first torque source. Another operation includes determining whether the first torque error exceeds a torque error threshold. When the first torque error exceeds the torque error threshold, the operations include activating a first supplemental torque source of the plurality of the torque sources to provide a first supplemental torque output to the vehicle drive system.

This aspect of the disclosure may include one or more of the following optional features. In some examples, the operations further include obtaining a supplemental available torque source output of the first supplemental torque source, calculating an aggregate torque error based on the requested torque output and the supplemental available torque source output, determining whether the aggregate torque error exceeds the torque error threshold, and when the aggregate torque error exceeds the torque error threshold, instructing a second supplemental torque sources of the plurality of the torque sources to provide a second supplemental additional torque output to the vehicle drive system.

In some examples, the operations further include determining the requested torque output based on a measured vehicle speed and a requested vehicle speed. In some configurations, the first available torque source output includes at least one of an instantaneous current torque source output component and a maximum current torque source output component. In some implementations, activating the first supplement torque source from the plurality of torque sources includes activating an available one of the torque sources having a highest efficiency score. In some examples, the plurality of torque sources includes one or more electric motors. In some implementations, the plurality of torque sources includes an internal combustion engine.

In some examples, the operations further include instructing the first supplemental torque source to execute a ramp-up period prior to providing the first supplemental torque output. In these examples, the ramp-up period includes operating the first supplemental torque source in an unloaded state prior to providing the first supplemental torque output.

Another aspect of the disclosure provides a computer-implemented method that, when executed by data processing hardware of a vehicle having a vehicle drive system and plurality of torque sources connected to the vehicle drive system, causes the data processing hardware to perform operations. The operations include instructing a first torque source of the plurality of torque sources to provide an instantaneous torque to the vehicle drive system, receiving a requested torque output for the vehicle drive system, obtaining a first available torque source output of the first torque source, calculating a first torque error based on the requested torque output and the first available torque source output for the first torque source, and determining whether the first torque error exceeds a torque error threshold. When the first torque error exceeds the torque error threshold, the operations include obtaining efficiency scores for one or more supplemental torque sources and selecting a first supplemental torque source having a highest efficiency score from the plurality of the supplemental torque sources to provide a first supplemental torque output to the vehicle drive system.

In some examples, the operations further include selecting an internal combustion engine as the first supplemental torque source and instructing the internal combustion engine to execute a ramp-up procedure to warm the internal combustion engine in an unloaded state prior to providing the first supplemental torque output to the vehicle drive system.

### BRIEF DESCRIPTION OF THE DRAWINGS

The drawings described herein are for illustrative purposes only of selected configurations and are not intended to limit the scope of the present disclosure.

FIG. 1 is a schematic view of an example arrangement of a vehicle control system according to the principles of the present disclosure; and

FIG. 2 in an example arrangement of operations for a vehicle to implement using the control system of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises.” “comprising.” “including,” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on.” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term memory may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry. e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

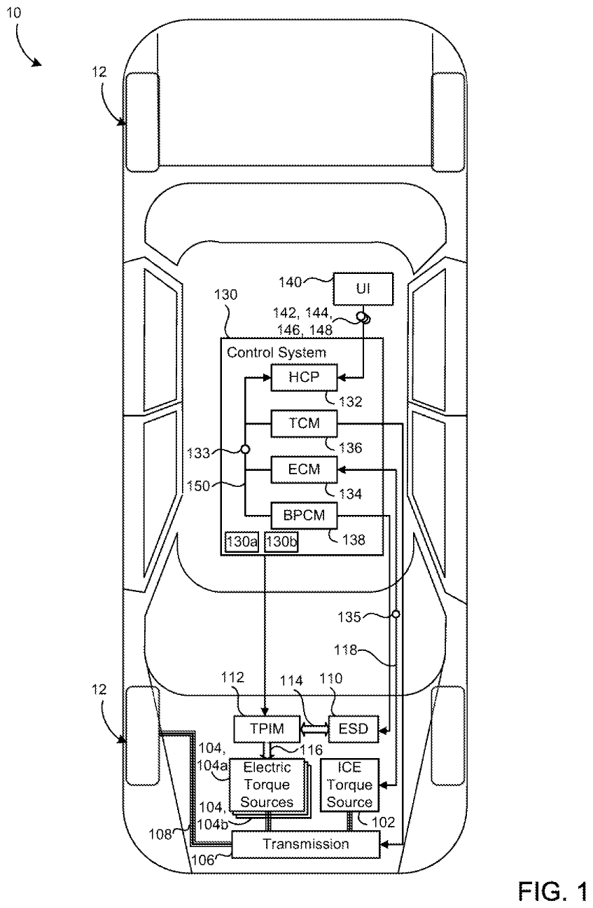

Referring now to the drawings, wherein the showings are for the purpose of illustrating aspects of the disclosure only and not for the purpose of limiting the same, FIG. 1 shows a vehicle 10 including a vehicle drive system 100 and a system controller 130 configured in accordance with an example of the present disclosure. In the illustrated example, the vehicle drive system 100 includes a hybrid vehicle drive system 100 having a plurality of torque sources 102, 104 operable to supply motive torque to a transmission 106, which supplies motive torque to a driveline 108. The torque sources may include an internal combustion engine 102 and one or more electric motors 104 operable to convert electrical energy supplied from an energy storage device 110 to generate motive torque.

In the illustrated example, the transmission 106 may include a two-mode, compound-split, electro-mechanical transmission 106 having fixed gear ratios, and includes a plurality of gears operable to transmit the motive torque to the driveline 108 through a plurality of torque-transfer devices contained therein. While the illustrated example shows the torque sources 102, 104 providing torque (illustrated by the compound connecting lines) to a single transmission 106, it should be appreciated that the torque sources 102, 104 may provide torque to one or more independent transmissions 106 coupled to one or more drivelines 108. For instance, where included, an internal combustion engine 102 may be coupled to a first transmission 106 while electric motors 104 may be coupled to a second transmission 106. Alternatively, the electric motors 104 may be coupled directly to independent drivelines at one or more wheels 12 of the vehicle 10.

The illustrated vehicle drive system 100 is configured in accordance with an aspect of the present disclosure. The transmission 106 receives input torque from torque sources 102, 104, including the internal combustion engine 102 and the electric motors 104, as a result of energy conversion from fuel or electrical potential stored in an electrical energy storage device (ESD) 110. The ESD 110 typically includes one or more batteries. Other electrical energy storage devices that have the ability to store electric power and dispense electric power may be used in place of the batteries without altering the concepts of the present disclosure. The ESD 110 is sized based upon factors including regenerative requirements, application issues related to typical road grade and temperature, and propulsion requirements such as emissions, power assist, and electric range. The ESD 110 is high voltage DC-coupled to transmission power inverter module (TPIM) 112 via DC lines referred to as the ESD transfer conductor 114. The TPIM 112 transfers electrical energy to the one or more electric motors 104 by motor transfer conductors 116. Electrical current is transferable between the electric motors 104 and the ESD 110 in accordance with whether the ESD 110 is being charged or discharged. TPIM 112 includes the power inverters and respective motor control modules configured to receive motor control commands and control inverter states therefrom to provide motor drive or regeneration functionality.

The electric motors 104 include motor/generator devices. In motoring control, the respective inverter receives current from the ESD 110 and provides AC current to the respective motor 104 over motor transfer conductors 116. In regeneration control, the respective inverter receives AC current from the electric motor 104 over the respective motor transfer conductor 116 and provides current to the ESD transfer conductors 114. The net DC current provided to or from the inverters determines the charge or discharge operating mode of the ESD 110.

The elements shown in FIG. 1, and described hereinafter, provide a subset of an overall vehicle control architecture, and are operable to provide coordinated system control of the vehicle drive system 100 described herein. The system controller 130 is operable to gather and synthesize pertinent information and inputs, and execute algorithms to control various actuators to achieve control targets. The control targets include such parameters as fuel economy, emissions, performance, driveability, and protection of hardware, including batteries of the ESD 110 and the one or more electric motors 104. The distributed control module architecture of the system controller 130 comprises an engine control module (ECM) 134, a transmission control module (TCM) 136, a battery pack control module (‘BPCM’) 138, and the Transmission Power Inverter Module (TPIM) 112. A hybrid control module (HCM) 132 provides overarching control and coordination of the aforementioned control modules. The vehicle may include a user interface (UI) 140 operably connected to a plurality of devices through which a vehicle operator typically controls or directs operation of the powertrain, including the transmission 106. Example vehicle operator inputs to the UI 140 include an accelerator pedal input 142, a brake pedal input 144, a transmission gear selector input 146, and, a vehicle speed cruise control input 148. Within the system controller 130 and the vehicle 10, each of the aforementioned control modules 132, 134, 136, 138 communicates with other control modules, sensors, and actuators via a local area network (LAN) communications bus 150. The LAN communication bus 150 allows for structured communication of control parameters and commands between the various control modules and components of the vehicle drive system 100. The specific communication protocol utilized is application-specific. By way of example, one communications protocol is the Society of Automotive Engineers standard J1939. The LAN bus and appropriate protocols provide for robust messaging and multi-control module interfacing between the aforementioned control modules, and other control modules providing functionality such as antilock brakes, traction control, and vehicle stability.

The HCM 132 provides overarching control of the hybrid vehicle drive system, serving to coordinate operation of the ECM 134, the TCM 136, the TPIM 112, and the BPCM 138. Based upon various input signals from the UI 140 and the vehicle drive system 100, the HCM 132 generates various requests or commands, including: an internal combustion engine torque command, clutch torque commands for various clutches of the hybrid transmission 106, and motor torque commands for the electric motors 104, respectively.

The ECM 134 is operably connected to the internal combustion engine 102, and functions to acquire data from a variety of sensors and control a variety of actuators, respectively, of the internal combustion engine 102 over a plurality of discrete lines collectively shown as aggregate line 118. The ECM 134 receives a vehicle axle torque request 133 from the HCM 132, and generates internal combustion engine torque instructions 135. For simplicity, the ECM 134 is shown generally having a bi-directional interface with engine 102 via aggregate line 118. Various parameters that are sensed by the ECM 134 include engine coolant temperature, engine input speed to the transmission, manifold pressure, ambient air temperature, and ambient pressure. Various actuators that may be controlled by the ECM 134 include fuel injectors, ignition modules, and throttle control modules.

The TCM 136 is operably connected to the transmission 106 and functions to acquire data from a variety of sensors and provide command control signals (i.e. clutch torque commands) to the clutches of the transmission 106. The BPCM 138 interacts with various sensors associated with the ESD 110 to provide information about the state of the ESD 110 to the HCM 132. Such sensors comprise voltage and electrical current sensors, as well as ambient sensors operable to measure operating conditions of the ESD 110 including, for example . . . temperature and internal resistance of the ESD 110. Sensed parameters may include ESD voltage V_{BAT}. ESD current I_{BAT}, and ESD temperature T_{BAT}. Derived parameters may include. ESD internal resistance R_{BAT}. ESD state of charge SOC, and other states of the ESD, including available electrical power. P_{BAT-MIN} and P_{BAT-MAX}.

The transmission power inverter module (TPIM) 112 includes the aforementioned power inverters and motor control modules configured to receive motor control commands and control inverter states therefrom to provide motor drive or regeneration functionality. The TPIM 112 is operable to generate electric motor torque instructions 113 for the electric motors 104 based upon the axle torque request 133 from the HCM 132, which is driven by operator input through the UI 140 and system operating parameters. Motor torques are implemented by the system controller 130, including the TPIM 112, to control the electric motors 104. Individual motor speed signals are derived by the TPIM 112 from the motor phase information or conventional rotation sensors. The TPIM 112 determines and communicates motor speeds to the HCM 132.

The system controller 130 and/or any of the aforementioned control modules 134, 136, 138, 132 of the control system 130 may be incorporated as a general-purpose digital computer generally comprising a microprocessor or central processing unit 130a and memory hardware 130b, including read only memory (ROM), random access memory (RAM), electrically programmable read only memory (EPROM), high speed clock, analog to digital (A/D) and digital to analog (D/A) circuitry, and input/output circuitry and devices (I/O) and appropriate signal conditioning and buffer circuitry. Each control module 134, 136, 138, 132 has a set of control algorithms, comprising resident program instructions and calibrations stored in the memory hardware and executed to provide the respective functions of each computer. Information transfer between the various computers may be accomplished using the aforementioned network 150.

Algorithms for control and state estimation in each of the control modules 134, 136, 138, 132 are typically executed during preset loop cycles such that each algorithm is executed at least once each loop cycle. Algorithms stored in the non-volatile memory devices are executed by one of the central processing units and are operable to monitor inputs from the sensing devices and execute control and diagnostic routines to control operation of the respective device, using preset calibrations. Loop cycles are typically executed at regular intervals, for example each 3.125, 6.25, 12.5, 25, and 100 milliseconds during ongoing engine and vehicle operation. Alternatively, algorithms may be executed in response to occurrence of an event.

The action described hereinafter occurs during active operation of the vehicle, which includes the period of time when operation of the engine and electric motors are initiated by the vehicle operator, typically through a ‘key-on’ action. Quiescent periods include periods of time when operation of the engine and electric motors are disabled by the vehicle operator, typically through a ‘key-off’ action. In response to an operator's action, as captured by the UI 140, the supervisory HCM 132 and one or more of the other control modules 136 determine required transmission output torque, Tₒ. Selectively operated components of the vehicle drive system 100 are appropriately controlled and manipulated to respond to the operator demand. For example, in the example shown in FIG. 1, when the operator has selected a forward drive range and manipulates either the accelerator pedal or the brake pedal, the HCM 132 determines how and when the vehicle is to accelerate or decelerate. The HCM 132 also monitors the parametric states of the torque sources 102, 104, and determines the output of the transmission 106 required to effect a desired rate of acceleration or deceleration. Under the direction of the HCM 132, the vehicle drive system 100 operates over a range of output speeds from slow to fast in order to meet the operator demand.

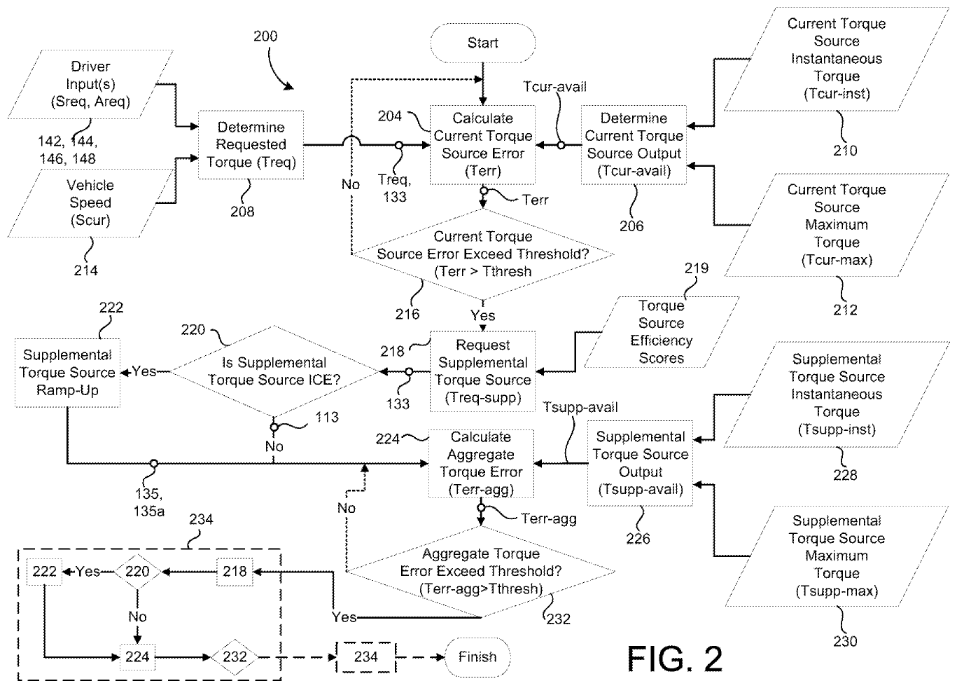

Referring now to FIG. 2, a computer-implemented method 200 of coordinating torque output Tₒ for the vehicle torque sources 102, 104 is provided. The method 200 may be provided as a collection of instructions executed by one or more of the aforementioned control modules 132, 134, 136, 138 of the system controller 130 in response to one or more of the inputs 142, 144, 146, 148 received from the UI 140. Generally, the method 200 provides a metric that receives a driver input (e.g., accelerator input 142) and evaluates the input to control torque output at the torque sources 102, 104, such as the electric motors 104 only or the electric motors 104 in combination with the internal combustion engine 102. This method ensures a maximum utilization of the higher efficiency torque sources (e.g., the electric motor 104) before and during the activation of lower efficiency torque sources (e.g., the internal combustion engine 102) to provide additional torque and satisfy driver input. This method 200 allows coordinated torque distribution between the two (or more) torque sources 102, 104 and optimizes catalyst light-off performance in the most efficient manner. Additionally, this new method 200 allows for a more efficient application of the torque sources 102, 104 and results in improved emissions performance on applications with hybrid (electric plus internal combustion engine) torque sources.

At a first operation 204, the system controller 130 calculates a current torque source error Tₑᵣᵣ or differential based on a requested torque output T_{req} and an available current torque source output torque T_{cur-avail}. For example, the vehicle drive system 100 may initially be operating in a steady state (e.g., no acceleration), whereby a first one of the electric motors 104 is providing the entire torque input Tₜᵣₐₙₛ to the transmission 106. When a driver depresses the accelerator, the system controller 130 receives or obtains the current torque source output T_{cur} (operation 206) and the requested torque output T_{req} (operation 208) and calculates an error or deficiency of the available current torque source output T_{cur-avail} relative to the requested torque output T_{req}.

At operation 206, the system controller 130 determines the available current torque source output T_{cur-avail}, which corresponds to the total available torque output of the first one of the electric motors 104. The available current torque source output T_{cur-avail} may include an instantaneous current torque source output T_{cur-inst} component 210, which corresponds to the current torque output from the first one of the electric motors 104, and a maximum current torque source output T_{cur-max} component 212, which corresponds to the maximum available torque output that can be delivered by the first one of the electric motors 104 to the transmission 106.

At operation 204, the system controller 130 also receives a requested driver torque T_{req}, which corresponds to a calculated torque value necessary to satisfy one or more driver inputs 142, 144, 146, 148 received from the UI 140. For example, at operation 208, the system controller 130 calculates the requested torque T_{req} associated with the accelerator pedal input 142, whereby a driver depresses the accelerator pedal to increase power output (i.e., speed) of the vehicle 10. The requested torque T_{req} may be calculated as a function of the requested vehicle speed S_{req} and the requested acceleration rate A_{req}, which are determined based on the accelerator pedal input 142, and the current vehicle speed 214 (S_{cur}) obtained from one or more vehicle speed sensors. Using the requested torque T_{req} and the available current torque source output T_{cur-avail}, the system controller 130 calculates a magnitude of a current torque source error Tₑᵣᵣ, which corresponds to a calculated difference between the requested torque T_{req} and the available current torque source output T_{cur-avail}. In some examples, the calculation corresponds to an integral calculation between the requested torque T_{req} and the available current torque source output T_{cur-avail}. In other words, the calculation may be determined as a total calculated error over a period of time, either measured or estimated, rather than as an instantaneous error at a given point in time.

At operation 216, the system controller 130 evaluates whether the current torque source error Tₑᵣᵣ exceeds a torque source error threshold Tₜₕᵣₑₛₕ to determine whether or not to engage additional ones of the torque sources 102, 104. When the system controller 130 determines that the current torque source error Tₑᵣᵣ does not exceed the torque source error threshold Tₜₕᵣₑₛₕ, the system controller 130 concludes the current iteration of the method 200 and returns to the first operation 204 to start a subsequent iteration of the method 200.

Conversely, when the system controller 130 determines that the current torque source error Tₑᵣᵣ exceeds the torque source error threshold Tₜₕᵣₑₛₕ, the system controller 130 advances to operation 218 to activate a supplemental torque source 102, 104. At operation 218, the axle torque request 133 corresponds to a supplemental torque Tₛᵤₚₚ necessary to account for the current torque source error Tₑᵣᵣ associated with the current torque source 102, 104. The system controller 130 may be configured to prioritize activation of the supplemental torque sources 102, 104 of the vehicle 10 based on a weighted or scored efficiency value 219 for the supplemental torque sources 102, 104. For example, in a vehicle 10 having a primary electric motor 104a, one or more supplemental electric motors 104b, and an internal combustion engine 102, the system controller 130 may be configured such that the one or more supplemental electric motors 104b have a higher efficiency score than the internal combustion engine 102 and are assigned a greater weight. Thus, when the current torque source error Tₑᵣᵣ exceeds the torque source error threshold Tₜₕᵣₑₛₕ for the primary electric motor 104a, the system controller 130 will activate the one or more supplemental electric motors 104b before activating the internal combustion engine 102.

Depending on the configuration of the vehicle (e.g., electric vehicle, hybrid electric vehicle), the supplemental torque source 102, 104 may include an additional one of the electric motors 104b (e.g., in an electric vehicle or a hybrid vehicle with multiple electric motors) or the internal combustion engine 102 (e.g., in a hybrid vehicle). The system controller 130 executes a sub-operation 220 to determine whether to transmit the axle torque request 133 to either (i) another one of the electric motors 104b as electric motor torque instructions 113 or (ii) the internal combustion engine 102 as internal combustion engine torque instructions 135.

In scenarios where the supplemental torque source is one of the supplemental electric motors 104b (answer is “No” at operation 220), the system controller 130 transmits the axle torque request 133 to the TPIM 112, which generates the electric motor torque instructions 113 and activates the supplemental electric motor 104b to immediately provide the requested supplemental torque T_{req-supp} to the transmission 106. In other words, the supplemental electric motor 104b may not require a ramp-up period prior to providing the requested supplemental torque T_{req-supp}.

Conversely, in scenarios where the supplemental torque source is an internal combustion engine 102 (response is “Yes” at operation 220), the system controller 130) advances to operation 222 to generate internal combustion engine torque instructions 135. Here, the internal combustion engine torque instructions 135 may include ramp-up instructions 135a for activating the internal combustion engine 102 prior to providing the requested supplemental torque T_{req-supp} to the driveline 108. Generally, the ramp-up instructions 135a include parameters for operating the internal combustion engine 102 in an unloaded or low-load state to allow the internal combustion engine 102 to pre-heat to an optimized operating temperature prior to transitioning to a loaded state (e.g., providing the requested supplemental torque T_{req-supp}). The duration and rate of the ramp-up period are determined by the system controller 130 as a function of the torque source error Tₑᵣᵣ. For example, when the torque source error Tₑᵣᵣ is relatively large, the ECM 134 will instruct the internal combustion engine 102 to execute a relatively aggressive ramp-up period having a relatively short duration and high ramp-up rate. In other words, when supplemental torque is required immediately, the ramp-up period may be a minimum ramp-up period sufficient to warm the internal combustion engine 102 to a threshold minimum operating temperature. Conversely, when the torque source error Tₑᵣᵣ is relatively small, but still exceeds the torque source error threshold Tₜₕᵣₑₛₕ, the ECM 134 will instruct the internal combustion engine 102 to execute a relatively long ramp-up period at a low ramp-up rate, thereby allowing the internal combustion engine 102 to obtain an optimal operating temperature prior to providing the supplemental requested torque T_{req}-supp. By implementing the ramp-up period, the internal combustion engine 102 is operated at a maximum efficiency prior to and during application of the requested supplemental torque T_{req-supp}.

At operation 224, the system controller 130 calculates an aggregate torque source error T_{err-agg} for all activated torque sources 102, 104 providing torque to the transmission. At operation 224, the calculation of aggregate torque source error T_{err-agg} is similar to the calculation of the current torque source error Tₑᵣᵣ executed at operation 204. However, at operation 224, the system controller 130 calculates the aggregate torque source error T_{err-agg} based on the supplemental requested torque T_{req-supp} and a supplemental torque source output Tₛᵤₚₚ₋ₐᵥₐᵢₗ, which is a function of a supplemental torque source instantaneous torque Tₛᵤₚₚ₋ᵢₙₛₜ provided at input 228 and a supplemental torque source maximum source torque Tₛᵤₚₚ₋ₘₐₓ. In other words, the aggregate torque source error T_{err-agg} is based on the difference between the total torque requested (T_{req}+T_{req-supp}) and the total available torque provided by the activated torque sources (T_{cur-avail}+Tₛᵤₚₚ₋ₐᵥₐᵢₗ).

At operations 232, the system controller 130 evaluates whether the aggregate torque source error T_{err-agg} exceeds the torque source error threshold Tₜₕᵣₑₛₕ and, if so, proceeds to a subsequent torque evaluation 234 with respect to a subsequent one of the supplemental torque sources 102, 104b. As indicated by the dashed lines, each torque evaluation 234 includes respective iterations of operations 218, 220, 222, 224 associated with the subsequent one of the supplemental torque sources 102, 104b. Additional iterations of the torque evaluation 234 are executed for each available torque source 102, 104b until all supplemental torque sources 102, 104b are utilized.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that, when executed by data processing hardware of a vehicle having a vehicle drive system and plurality of torque sources connected to the vehicle drive system, causes the data processing hardware to perform operations comprising:
instructing a first torque source of the plurality of torque sources to provide an instantaneous torque to the vehicle drive system;
receiving a requested torque output of the vehicle drive system;
obtaining a first available torque source output of the first torque source;
calculating a first torque error based on the requested torque output and the first available torque source output for the first torque source;
determining whether the first torque error exceeds a torque error threshold; and
when the first torque error exceeds the torque error threshold, activating a first supplemental torque source of the plurality of the torque sources to provide a first supplemental torque output to the vehicle drive system.

2. The method of claim 1, wherein the operations further comprise:
obtaining a supplemental available torque source output of the first supplemental torque source;
calculating an aggregate torque error based on the requested torque output and the supplemental available torque source output;
determining whether the aggregate torque error exceeds the torque error threshold; and
when the aggregate torque error exceeds the torque error threshold, instructing a second supplemental torque sources of the plurality of the torque sources to provide a second supplemental additional torque output to the vehicle drive system.

3. The method of claim 1, wherein the operations further comprise determining the requested torque output based on a measured vehicle speed and a requested vehicle speed.

4. The method of claim 1, wherein the first available torque source output includes at least one of an instantaneous current torque source output component and a maximum current torque source output component.

5. The method of claim 1, wherein activating the first supplement torque source from the plurality of torque sources includes activating an available one of the torque sources having a highest efficiency score.

6. The method of claim 1, wherein the plurality of torque sources includes one or more electric motors.

7. The method of claim 6, wherein the plurality of torque sources includes an internal combustion engine.

8. The method of claim 1, wherein the operations further comprise instructing the first supplemental torque source to execute a ramp-up period prior to providing the first supplemental torque output.

9. The method of claim 8, wherein the ramp-up period includes operating the first supplemental torque source in an unloaded state prior to providing the first supplemental torque output.

10. A control system for a vehicle having a vehicle drive system and plurality of torque sources connected to the vehicle drive system, the control system comprising:
data processing hardware; and
memory hardware in communication with the data processing hardware, the memory hardware storing instructions that when executed on the data processing hardware cause the data processing hardware to perform operations comprising:
instructing a first torque source of the plurality of torque sources to provide an instantaneous torque to the vehicle drive system;
receiving a requested torque output for the vehicle drive system:
obtaining a first available torque source output of the first torque source;
calculating a first torque error based on the requested torque output and the first available torque source output for the first torque source;
determining whether the first torque error exceeds a torque error threshold; and
when the first torque error exceeds the torque error threshold, activating a first supplemental torque source of the plurality of the torque sources to provide a first supplemental torque output to the vehicle drive system.

11. The control system of claim 10, wherein the operations further comprise:
obtaining an supplemental available torque source output of the first supplemental torque source;
calculating an aggregate torque error based on the requested torque output and the supplemental available torque source output;
determining whether the aggregate torque error exceeds the torque error threshold; and
when the aggregate torque error exceeds the torque error threshold, instructing a second supplemental torque sources of the plurality of the torque sources to provide a second supplemental additional torque output to the vehicle drive system.

12. The control system of claim 10, wherein the operations further comprise determining the requested torque output based on a measured vehicle speed and a requested vehicle speed.

13. The control system of claim 10, wherein the first available torque source output includes at least one of an instantaneous current torque source output component and a maximum current torque source output component.

14. The control system of claim 10, wherein activating the first supplement torque source from the plurality of torque sources includes activating an available one of the torque sources having a highest efficiency score.

15. The control system of claim 10, wherein the plurality of torque sources includes one or more electric motors.

16. The control system of claim 15, wherein the plurality of torque sources includes an internal combustion engine.

17. The control system of claim 10, wherein the operations further comprise instructing the first supplemental torque source to execute a ramp-up period prior to providing the first supplemental torque output.

18. The control system of claim 17, wherein the ramp-up period includes operating the first supplemental torque source in an unloaded state prior to providing the first supplemental torque output.

19. A computer-implemented method that, when executed by data processing hardware of a vehicle having a vehicle drive system and plurality of torque sources connected to the vehicle drive system, causes the data processing hardware to perform operations comprising:
instructing a first torque source of the plurality of torque sources to provide an instantaneous torque to the vehicle drive system;
receiving a requested torque output for the vehicle drive system;
obtaining a first available torque source output of the first torque source;
calculating a first torque error based on the requested torque output and the first available torque source output for the first torque source;
determining whether the first torque error exceeds a torque error threshold; and
when the first torque error exceeds the torque error threshold, obtaining efficiency scores for one or more supplemental torque sources; and
selecting a first supplemental torque source having a highest efficiency score from the plurality of the supplemental torque sources to provide a first supplemental torque output to the vehicle drive system.

20. The computer-implemented method of claim 19, wherein the operations further comprise:
selecting an internal combustion engine as the first supplemental torque source; and
instructing the internal combustion engine to execute a ramp-up procedure to warm the internal combustion engine in an unloaded state prior to providing the first supplemental torque output to the vehicle drive system.
